(19) United States
(12) Patent Application Publication
(10) Pub. No.: US 2011/0241385 A1
(43) Pub. Date: Oct. 6, 2011

(54) Vehicle Frame with Direction-Specific Deformation

(75) Inventors: Mohamed Ridha Baccouche, Ann Arbor, MI (US); Saied Nusier, Canton, MI (US); Jamel E. Belwafa, Ann Arbor, MI (US); Michael M. Azzouz, Livonia, MI (US)

(73) Assignee: Ford Global Technologies LLC

(21) Appl. No.: 12/750,548

(22) Filed: Mar. 30, 2010

(51) Int. Cl. B62D 25/08; B23P 15/00

(52) U.S. Cl. 296/203.02; 29/897.2

(57) ABSTRACT

The present disclosure relates to a vehicle frame with direction-specific deformation. The frame includes a rail with bended hinge(s) configured to deform the frame in a lateral direction in response to a longitudinal impact force and methods of manufacturing the same.

### TECHNICAL FIELD

The present disclosure relates to a vehicle frame programmed with direction-specific deformation. For example, disclosed is a sub frame for the front portion of a vehicle frame which is configured to laterally deform upon frontal impact.

### BACKGROUND

A vehicle sub frame is a structural sub-system of the vehicle chassis that can carry or support other vehicle components, such as e.g., the engine, drive train or suspension. The sub frame can be bolted or welded to the vehicle. When bolted to the vehicle, the sub frame is equipped with rubber bushings to dampen or isolate vibration from the rest of the vehicle body. In a powertrain supporting sub frame forces generated by the engine and transmission can be dampened down enough so as not to disturb passengers. One common type of sub frame is the “K” brace type which usually carries a lower control arm, steering rack and/or provides support for the engine. Some front end structures with K-type sub frames manage crash energy through a single load path rail. The drawback of such architecture is a constrained design in terms of relatively low load and significant deceleration levels in the structure at various locations (i.e., the bumper, crash can and front rails) early in the crash event, e.g., at 10-15 msec. It is accordingly desirable to have additional crash energy management, weight reduction and lower load path attributes.

One patent teaches an angular and frontal energy absorbing vehicle frame structure—U.S. Pat. No. 5,429,388. The '388 patent teaches a front end structure that connects to left and right frame members in a manner to cause them to laterally deform in response to a lateral force component of a preselected magnitude. It is still desirable to have a sub frame structure that deforms in a different direction than the applied force upon impact—i.e., in front crash situations the frame being configured to translate longitudinal energy into lateral deformation. Moreover, a uniformed front sub frame is desirable to simplify manufacturing and reduce weight.

Additionally, more crash space can be provided by mounting vehicle components on the forward cross member of the sub frame. It is desirable to have a front sub frame that enables components to be mounted on the forward cross member of the sub frame.

Finally, it is therefore desirable to have a vehicle front frame programmed with direction-specific deformation. For example, it would be beneficial to have a vehicle front frame configured to deform in a lateral direction in response to a longitudinal impact force.

### SUMMARY

The present inventions address one or more of the above-mentioned issues. Other features and/or advantages may become apparent from the description which follows.

One embodiment of the present invention relates to a vehicle front frame, including: a rail, the rail including: a first portion extending laterally with respect to the vehicle; and a second portion extending longitudinally with respect to the vehicle; a first bended hinge between the first and second portions; and a second bended hinge between the first and second portions. The first bended hinge and second bended hinge are configured to deform the frame in a lateral direction in response to a longitudinal force.

Another exemplary embodiment of the present invention relates to a vehicle frame, including: a rail having a first portion and a second potion; and an intermediate bended hinge between the first and second potions. The intermediate bended hinge is torqued in a first direction with respect to the vehicle. The intermediate bended hinge is configured to deform the first portion of the rail in the first direction with respect to the vehicle in response to application of a force in a second direction.

Another exemplary embodiment of the present invention is a method of programming direction-specific deformation into a vehicle frame. The method includes: forming a rail having a first portion extending in a first direction and a second portion extending in a second direction; identifying a direction in which a force will be applied; identifying a direction in which the rail is intended to deform in response to the force; and forming a bended hinge in the rail, between the first and second portion, curved towards a direction opposite of the direction in which the rail is intended to deform.

Yet, another exemplary embodiment of the present invention relates to a method of manufacturing a vehicle sub frame configured to deform laterally upon frontal impact. The method includes: forming a rail; torquing the rail in a clockwise direction with respect to a lateral axis of the vehicle; and torquing the rail in a counterclockwise direction with respect to a longitudinal axis of the vehicle.

The present teachings provide at least three advantages over conventional sub frames related to crashworthiness, weight reduction and parts consolidation. In one embodiment, the sub frame includes a total of six new crash energy managing hinges. The proposed design is a relatively lightweight concept based on hydroforming aluminum extrusion having two-tier stiffness: a strong rear zone to manage dynamic forces from lower control arms and a weight saving middle and forward zones that manage crash energy. The forward most zone of the proposed concept allows for attaching the radiator to the front hydroformed beam of the sub frame thus eliminating radiator supports and brackets or attachments. Moreover, the proposed concept provides for more crash space as it eliminates the need to weld radiator brackets to the front rails and frees crash space otherwise occupied by radiator brackets.

Another advantage of the present disclosure is that the sub frame can be configured to deform in a lateral direction in response to a longitudinal impact force. The vehicle frame is programmed with direction-specific deformation.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

The invention will be explained in greater detail below by way of example with reference to the figures, in which the same references numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIG. 1 is a top view of front vehicle sub frame according to an exemplary embodiment of the present invention in a front crash situation.

FIG. 2 is a top view of a side of the sub frame of FIG. 1, taken along Section 2-2.

FIG. 3 is a top view of a side of another vehicle sub frame according to an exemplary embodiment of the present invention.

FIG. 4 is an exploded view of a sub frame according to another exemplary embodiment with a radiator core.

FIG. 5 is a comparative graph showing deformation at various points in the vehicle after application of a predetermined force; the comparison is made between contemporary designs and a sub frame according to an exemplary embodiment of the present invention.

FIG. 6 illustrates a method of programming direction-specific deformation into a vehicle frame according to an exemplary embodiment of the present invention.

Although the following detailed description makes reference to illustrative embodiments, many alternatives, modifications, and variations thereof will be apparent to those skilled in the art. Accordingly, it is intended that the claimed subject matter be viewed broadly.

### DETAILED DESCRIPTION

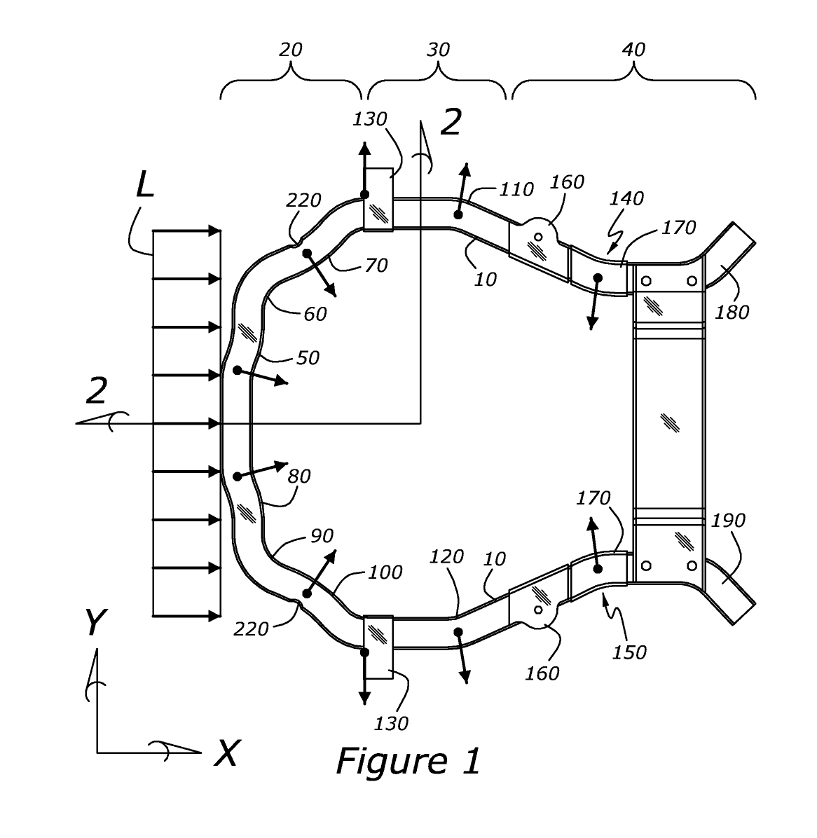

Referring to the drawings, FIGS. 1-6, wherein like characters represent the same or corresponding parts throughout the several views there are shown several exemplary vehicle frames with beneficial innovative features. The illustrated examples of the vehicle frame include front sub frames having impact mitigation features. Vehicle sub frames are programmed with direction-specific deformation. For example, a front vehicle sub frame is configured to laterally deform upon frontal impact. The vehicle frames are compatible with various types of vehicles including small/large cars, coupes, sedans, convertibles, trucks, vans, minivans, all utility vehicles and sports utility vehicles. Though the present teachings are discussed with respect to frontal impact situations, the crash mitigation techniques can be applied with respect to rear, side, rollover and/or other impact situations.

Referring now to FIG. 1, there is shown therein a top view of a vehicle front frame 10 (or sub frame). The frame 10 is shown in a free body diagram undergoing a front impact situation with a uniformly applied crash load (“L”); the load, L, is a longitudinal load applied across the front end of the sub frame 10. In this example, the load, L, can be approximately the same as a load resulting from a 35 mile per hour full frontal impact. Frame 10 is a rail that has a crash energy managing sub frame consisting of three zones 20, 30 and 40. The front zone 20 functions to manage crash energy through three bending hinges 50, 60, 70 and 80, 90, 100 on the passenger and driver sides of the vehicle, respectively. A lateral hinge, e.g., 70 and/or 100 is designed to transversally apply front impact forces (such as L) to the sub frame or rail attachment. In this manner, the sub frame 10 manages energy by lateral outboard bending, or bended hinges, around the longitudinal axis of the vehicle (or X-axis). Sub frame 10 is a uniform member. The architecture of the right and left sides of the frame 10 are mirrored in this embodiment. It is not necessary that the two sides are symmetrical in all other embodiments.

Frame 10 is programmed with direction-specific deformation to occur in response to load, L. Energy is absorbed by the local hinges. At hinges 50 and 80, as shown in FIG. 1, the sub frame 10 is designed to deform in a substantially longitudinal direction (or along the X-axis) in response to application of a longitudinal force (e.g., L). At hinge 60 and 90 the sub frame 10 is designed to deform in a substantially lateral direction (or along the Y-axis) but inward with respect to the sub frame. Longitudinal energy is absorbed by hinges 60, 90. At hinges 70 and 100 the sub frame 10 is designed to deform in a substantially lateral direction (or along the Y-axis), inward with respect to the sub frame. Hinges 70, 100 are in the outboard sides of the sub frame 10. Longitudinal energy is absorbed by the traversal outboard hinging.

The middle zone 30, as shown in FIG. 1, is designed to carry two bending hinges 110, 120 on each side of the sub frame 10. The sub frame is attachable to the vehicle's main rail via posts 130 located on each side of the middle zone 30. The sub frame 10 extends substantially longitudinally in the middle zone 30.

The rear most zone 40, as shown in FIG. 1, includes rear axial bends 140, 150 on the passenger and driver sides of the frame 10. The longitudinal portion of the sub frame 10 is configured to deform axially in response to load, L. Rear zone 40 of the sub frame 10 is designed to carry lower control arms through brackets 160, as shown in FIG. 1. The lower control arm (not shown) provides a mechanical linkage between a steering rack and vehicle wheels. Lower control arm attachment brackets 160 are shown in FIG. 1 attached to the sub frame 10. The rear zone 40 also supports a steering rack (not shown). The steering rack is attachable to the sub frame 10 via two brackets or attachments 170 that reinforce the steering rack. The sub frame 10 extends substantially longitudinally in the rear zone. Rear zone 40 further includes axial bends 180, 190. The longitudinal portion of the sub frame 10 is configured to deform axially in response to load, L.

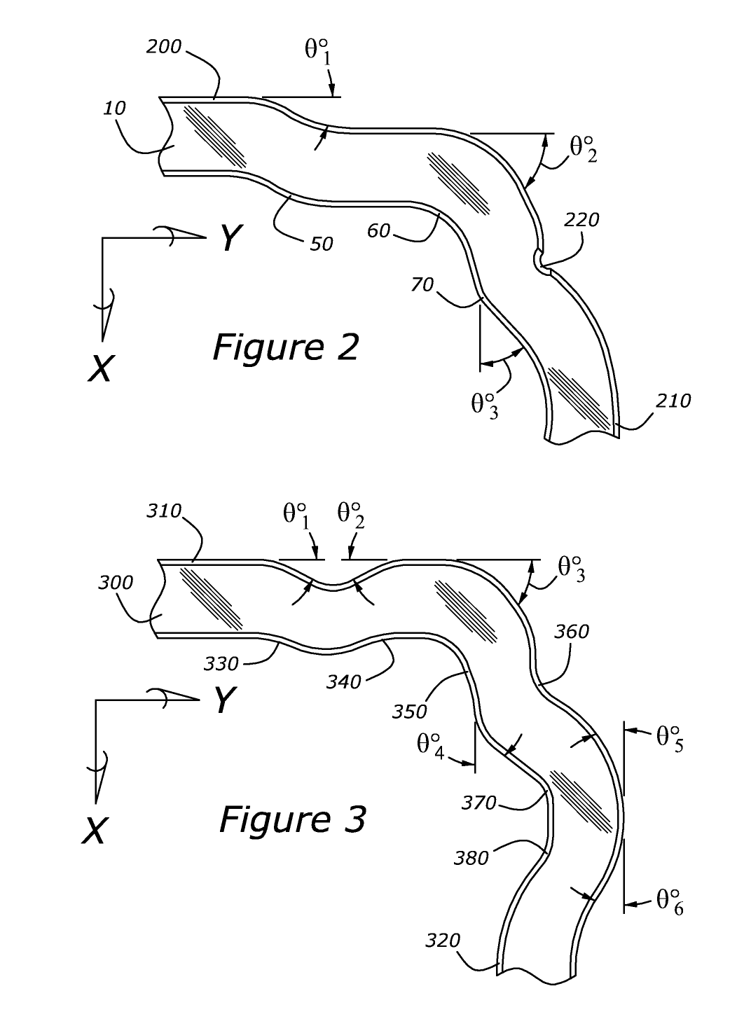

Referring now to FIG. 2, there is shown therein a quadrant of the sub frame 10 of FIG. 1 taken along section 2-2. Illustrated is the passenger side of the sub frame 10. In the illustrated embodiment, the rail 10 includes a laterally extending portion 200 and a longitudinally extending portion 210. Each portion 200, 210 extends along the lateral axis (Y) and the longitudinal axis (X) of the vehicle frame 10. Three bended hinges 50, 60 and 70 are included in the rail 10 between the laterally and longitudinally extending portions 200 and 210, respectively. Bended hinge 50 includes a bend angle, Θ₁, that is approximately 15 degrees from the Y-axis (or lateral axis) of the vehicle. Bend angle, Θ₁, for the bended hinge can be between e.g., 15 degrees and 75 degrees from the lateral axis. Hinge 50 is torqued in a clockwise or positive direction with respect to the top-down view shown. Hinge 50 is torqued with respect to an axial direction of the vehicle.

The rail 10 includes a bended hinge 60 between hinges 50 and 70. Hinge 60 includes a bend angle, Θ₂, that is approximately 45 degrees from the Y-axis of the vehicle. Bend angle, Θ₂, for the bended hinge 60 can be between 15 degrees and 75 degrees from the lateral axis (Y). Hinge 60 is torqued in a clockwise direction with respect to the top view shown.

Rail 10 is torqued in a different direction at bended hinge 70. The bend angle, Θ₃, for bended hinge 70 can be e.g., between −5 degrees and −75 degrees from the X-axis (or longitudinal axis). Hinge 70 includes a bend angle, Θ₃, of approximately −30 degrees with respect to the X-axis of the vehicle frame 10. Hinge 70 is torqued in a counterclockwise direction with respect to the top view shown. Hinge 70 is configured to deform the longitudinally extending portion 210 of the rail in a lateral direction in response to application of the longitudinal force, L.

A notch 220 is formed in bended hinge 70. Notch 220 is formed on an outboard surface of the rail 10. Notch 220 also provides a means for programming direction-specific deformation into the rail 10. Notch 220 assists in enabling hinge 70 to laterally deform when a longitudinal force, L, is applied.

Referring now to FIG. 3, there is shown therein a quadrant of a sub frame 300 according to another exemplary embodiment of the present invention. A passenger side of the sub frame 300 is shown. The sub frame 300 is configured to translate longitudinal energy into lateral deformation. The illustrated rail 300 includes a laterally extending portion 310 and a longitudinally extending portion 320. Each portion 310 and 320 extends along the lateral axis (Y) and the longitudinal axis (X) of the vehicle frame 300. Six bended hinges 330, 340, 350, 360, 370 and 380 are included in the rail 300 between the laterally and longitudinally extending portions 310 and 320, respectively. Bended hinge 330 includes a bend angle, Θ₁ that is approximately 10 degrees from the Y-axis of the vehicle. Bended hinge 330 can be considered to be an intermediate bended hinge as it is positioned between the laterally and longitudinally extending portions 310 and 320 of the rail. Hinge 330 is torqued in a clockwise or positive direction with respect to the top-down view shown. Another lateral bend is included in the rail 300. Bended hinge 340 includes a bend angle, Θ₂ that is approximately −10 degrees from the Y-axis of the vehicle. Hinge 340 is torqued in a counterclockwise or negative direction with respect to the top-down view shown. Bended hinge 340 can be considered to be an intermediate bended hinge as it is positioned between the laterally and longitudinally extending portions 310 and 320 of the rail.

The rail 300, as shown in FIG. 3, includes another intermediate bended hinge 350. Hinge 350 includes a bend angle, Θ₃ that is approximately 45 degrees from the Y-axis of the vehicle. Hinge 350 is torqued in a clockwise direction with respect to the top view shown. Rail 300 is torqued in a different direction at bended hinge 360. Hinge 360 includes a bend angle, Θ₄, of approximately −20 degrees with respect to the X-axis of the vehicle frame 300. Hinge 360 is torqued in a counterclockwise direction with respect to the top view shown. Hinge 360 is configured to deform the longitudinally extending portion 320 of the rail 300 in a lateral direction in response to application of a longitudinal force.

Rail 300 is torqued in a clockwise direction at bended hinge 370. Hinge 370 includes a bend angle, Θ₅, of approximately 35 degrees with respect to the X-axis of the vehicle. Hinge 370 is torqued in a clockwise direction with respect to the top view shown. Rail 300 is then torqued in the same direction (or clockwise) at bended hinge 380. Hinge 380 includes a bend angle, Θ₆, of approximately 35 degrees with respect to the X-axis of the vehicle.

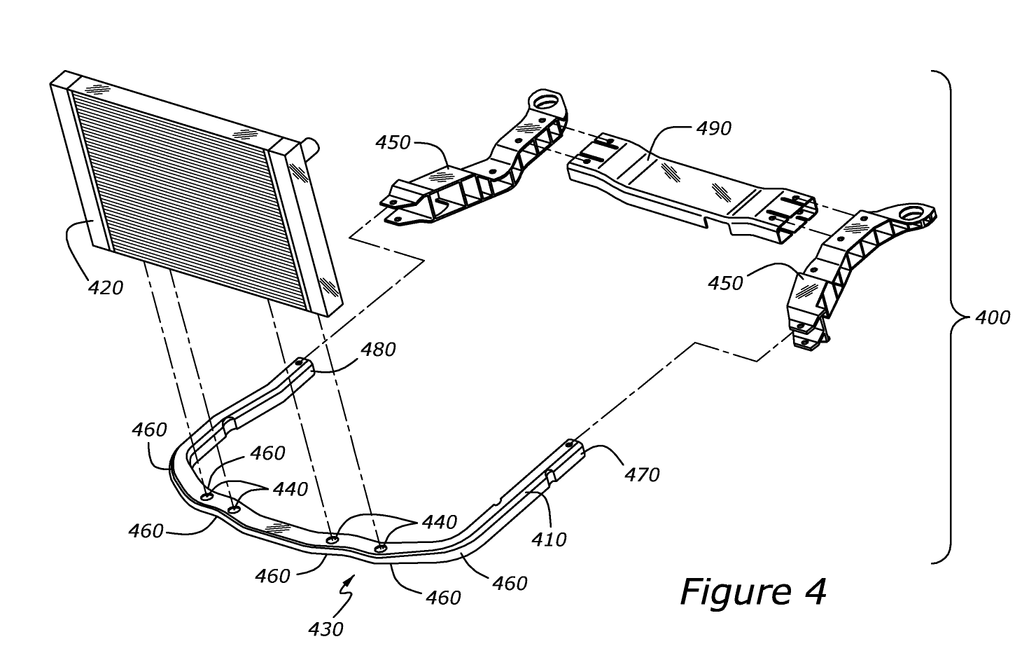

FIG. 4 is an exploded view of a vehicle frame assembly 400 according to another exemplary embodiment. The frame assembly 400 includes a rail or sub frame 410 that is shown with a radiator core 420. A forward zone 430 of the sub frame 410 is designed with dual functionality. First, the forward zone 430 of the frame 410 includes mounting fixtures 440 for securing and/or supporting vehicle components. The mounting fixtures 440 are formed with or into the rail 410. Mounting fixtures 440 can be configured to be compatible with various vehicle components, such as for example a radiator, engine, battery, HVAC or front fascia. In this embodiment, the forward zone 430 is configured to support at least a portion of a radiator (e.g., radiator core 420). Mounting fixture 440 is an aperture for mounting the radiator core 420 thereto. Radiator core 420 includes fastening features (not shown) that are matable with the mounting fixtures 440. Additional brackets are unnecessary.

The sub frame 410 is a uniform member, separable or detachable from a vehicle main frame 450, as shown in FIG. 4. Sub frame 410 includes a plurality of bended hinges 460 in the forward zone 430 of the frame. Sub frame 410 is a uniform, hollow member. Frame 410 has a substantially uniform cross-sectional thickness throughout. In another embodiment, the cross-sectional thickness of the frame varies. In this embodiment, sub frame 410 is hydroformed from a single rail. Other manufacturing techniques can also be employed, such as e.g., stamping, extrusion, casting or welding.

Sub frame 410 is a U-shaped member having a first end 470 and a second end 480. Each end 470, 480 is attachable to the main frame 450 through brackets. A beam 490 extends between each bracket 450. The beam 490 is a part of the main frame. A roll restrictor bracket (not shown) attaches to the beam 490. The sub frame 410 can attach to the main frame brackets 450 via any fastening means e.g., bolts, welds or clamps.

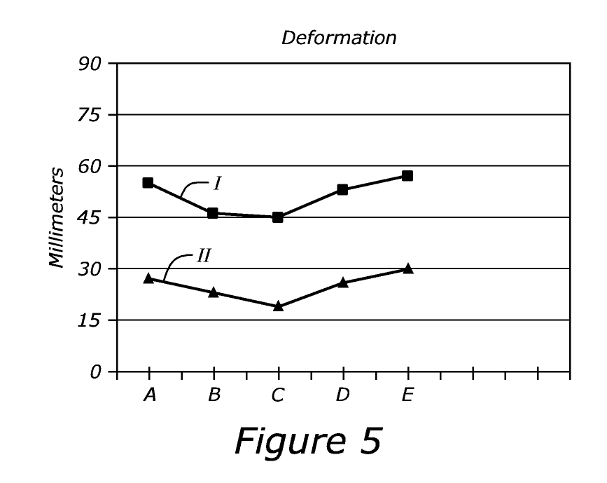

Referring now to FIG. 5, there is shown therein a comparative graph illustrating deformation (or intrusion) at various points in a vehicle after application of a predetermined force. The Y-axis shows the deformation (in millimeters) at various points in the vehicle upon application of a force simulating 35 miles per hour full frontal impact. The present teachings significantly reduce deformation at different points with respect to the vehicle. Line I illustrates deformation with a conventional sub frame and Line II illustrates deformation with an exemplary embodiment of the present invention. The comparison is made between a contemporary design and a sub frame according to the present teachings. Point A shows the amount of deformation at or near the vehicle brake pedal. With design I deformation can be approximately 55 millimeters versus approximately 27 millimeters with design II. Point B shows the amount of deformation at or near the vehicle footrest. With design I deformation can be 45 millimeters versus approximately 20 millimeters with design II. Point C shows the amount of deformation at or near the left toe pan on the driver's side. With design I deformation can be 45 millimeters versus approximately 17 millimeters with design II. Point D shows the amount of deformation at or near the center toe pan. With design I deformation can be 50 millimeters versus approximately 22 millimeters with design II. Point E shows the amount of deformation at or near a right toe pan on the driver's side. With design I deformation can be 57 millimeters versus approximately 30 millimeters with design II.

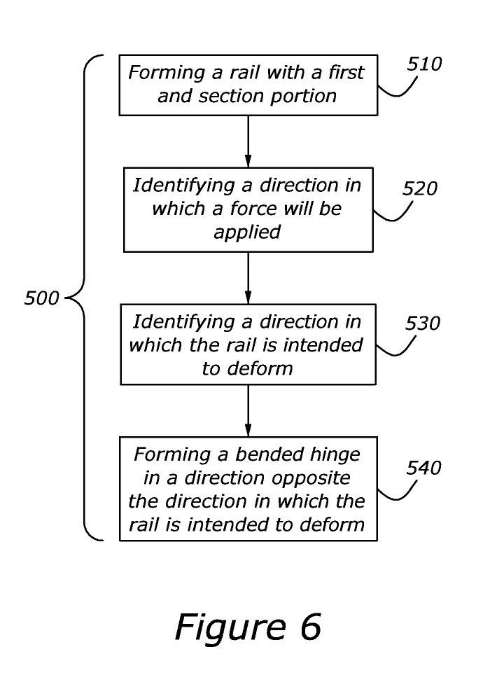

FIG. 6 illustrates a method 500 of programming direction-specific deformation into a vehicle frame according to an exemplary embodiment. The method 500 involves a procedure for manufacturing the vehicle frame with a mechanical algorithm for deformation in response to an applied load. The method 500, as shown in FIG. 6, includes the steps of: forming a rail having a first portion extend in a first direction and a second portion extending in a second direction 510. An exemplary rail 10 is shown in FIG. 1. The next step, 520, involves identifying a direction in which a force will be applied and the step 530—identifying a direction in which the rail is intended to deform in response to the force. As shown with respect to FIG. 1, an intended direction in which a force can be applied may be, for example, a longitudinal direction (or along the X-axis) as is typically applied in frontal impact situations. The direction intended for deformation can be in the lateral direction towards the outboard rail of the sub frame 10. Finally, the method 500 of FIG. 6 includes the step of forming a bended hinge in the rail 540, between the first and second portion, curved towards a direction opposite of the direction in which the rail is intended to deform. As shown in FIG. 1, for example, bended hinge 70 is curved towards the inboard surface of the rail in the lateral direction or along the Y-axis. The rail is thereby configured to deform towards the outboard surface of the rail in the lateral direction. The rail is curved towards a direction opposite the direction in which the rail is intended to deform. The method 500 can be implemented with respect to other vehicle components. For example, in one embodiment the method is employed to mitigate rear impact situations. The rear frame is programmed with direction-specific deformation so as to deform laterally toward the outboard rail(s) of the frame upon application of a rear longitudinal force. In another embodiment, the method includes the step of forming a notch, such as e.g., 220 as shown in FIG. 1 into the rail. Notch 220 further enables deformation as it provides a structural weaker point in the frame 10, encouraging deformation in the corner of bended hinge 70 or 100. Notches can be formed via stamping or hydroforming for example.

Also instructed herein is a method of manufacturing a vehicle sub-frame configured to deform laterally upon frontal impact. The method results in configuring a vehicle sub frame to deform laterally upon frontal impact. The method includes the following steps. First, forming a rail (e.g., 10 as shown in FIG. 2). The next step is torquing the rail in a clockwise direction with respect to a lateral axis of the vehicle (e.g., incorporating a bend angle of 60 as shown in FIG. 2). The final step involves torquing the rail in a counterclockwise direction with respect to a longitudinal axis of the vehicle (e.g., incorporating a bend angle of 70 as shown in FIG. 2). In one embodiment, the torquing of the rail is performed via tube hydroforming. The rail can be extruded or formed using hydroforming techniques. A die or casting is provided with the programmed bend angles. A high pressured fluid is applied to the rail to torque the rail in accordance with the profile of the tool. The fluid can be applied at a pressure of 25,000 psi for example. In one embodiment, the method further includes torquing the rail in a clockwise direction with respect to the longitudinal axis of the vehicle (e.g., incorporating a bend angle of Θ₂ equal to 45 degrees as shown in FIG. 2). Tube can also be manufactured using other techniques such as, for example, stamping, cutting, welding or extrusion. A notch, such as e.g., 220 as shown in FIG. 1 can be formed into the rail.

The present teachings further reduce the deceleration pulse generated upon impact over time. For example, in some experiments one exemplary embodiment showed an average reduction in deceleration of as much as 10 Gs when compared to contemporary designs approximately 40-60 milliseconds after impact. The same embodiment demonstrated a reduction of vehicle pulse index around the magnitude of 10 units when compared against contemporary designs.

Pulse generation data was also taken against deformation or crush. The data demonstrates that the present teachings also reduce the deceleration pulse generated upon impact for a given deformation level. At points beyond 500 millimeters of deformation, the deceleration measured was reduced by 10 Gs. In the same experiment, the measured deceleration was reduced by as much as 25 Gs at a deformation level of approximately 620 millimeters.

The frames and sub frames disclosed herein can be composed of various materials including, for example, high strength aluminum, steel or titanium. Other metals and high-strength polymers are also compatible with the present teachings.

It will be apparent to those skilled in the art that various modifications and variations can be made to the methodologies of the present invention without departing from the scope of its teachings. Other embodiments of the invention will be apparent to those skilled in the art from consideration of the specification and practice of the teachings disclosed herein. It is intended that the specification and examples be considered as exemplary only.

While the best modes for carrying out the invention have been described in detail, those familiar with the art to which this invention relates will recognize various alternative designs and embodiments for practicing the invention within the scope of the appended claims.

We claim:

1. A vehicle front frame, comprising:
a rail, the rail including:
a first portion extending laterally with respect to the vehicle; and
a second portion extending longitudinally with respect to the vehicle;
a first bended hinge between the first and second portions; and
a second bended hinge between the first and second portions;
wherein the first bended hinge and second bended hinge are configured to deform the frame in a lateral direction in response to a longitudinal force.

2. The front frame of claim 1, wherein the first bended hinge includes a positive bend angle with respect to a lateral axis of the vehicle.

3. The front frame of claim 2, wherein the bend angle for the first bended hinge is between 15 degrees and 75 degrees from the lateral axis.

4. The front frame of claim 1, wherein the second bended hinge includes a negative bend angle with respect to a longitudinal axis of the vehicle.

5. The front frame of claim 4, wherein the bend angle for the second bended hinge is between −5 degrees and −75 degrees from the longitudinal axis.

6. The front frame of claim 1, wherein the rail comprises a third bended hinge between the first and second bended hinges.

7. The front frame of claim 6, wherein the third bended hinge includes a positive bend angle with respect to the lateral axis of the vehicle.

8. The front frame of claim 1, wherein the rail further includes a mounting fixture formed into the rail for securing a radiator thereto.

9. The front frame of claim 8, wherein the mounting fixture is an aperture.

10. The front frame of claim 1, further comprising a notch in at least one of the bended hinges.

11. The front frame of claim 1, wherein the front frame is a uniform member.

12. The front frame of claim 11, wherein the front frame is detachable from a main vehicle frame.

13. A vehicle frame, comprising:
a rail having a first portion and a second potion; and
an intermediate bended hinge between the first and second potions;
wherein the intermediate bended hinge is torqued in a first direction with respect to the vehicle;
wherein the intermediate bended hinge is configured to deform the first portion of the rail in the first direction with respect to the vehicle in response to application of a force in a second direction.

14. A method of programming direction-specific deformation into a vehicle frame, the method comprising:
forming a rail having a first portion extending in a first direction and a second portion extending in a second direction;
identifying a direction in which a force will be applied;
identifying a direction in which the rail is intended to deform in response to the force; and
forming a bended hinge in the rail, between the first and second portion, curved towards a direction opposite of the direction in which the rail is intended to deform.

15. The method of claim 14, wherein the forming a bended hinge is performed via tube hydroforming.

16. The method of claim 14, further comprising forming a notch in the bended hinge.

17. A method of manufacturing a vehicle sub frame configured to deform laterally upon frontal impact, comprising:
forming a rail;
torquing the rail in a clockwise direction with respect to a lateral axis of the vehicle; and
torquing the rail in a counterclockwise direction with respect to a longitudinal axis of the vehicle.

18. The method of claim 17, further comprising:
notching the rail to further enable deformation.

19. The method of claim 17, wherein a torquing of the rail is performed via tube hydroforming.

20. The method of claim 17, further comprising:
torquing the rail in a clockwise direction with respect to the longitudinal axis of the vehicle.
